(19) United States
(12) Patent Application Publication
(10) Pub. No.: US 2024/0026645 A1
(43) Pub. Date: Jan. 25, 2024

(54) CONSTRUCTION MACHINES WITH REDUCED LATENCY ACTUATOR CONTROLS

(71) Applicant: HUSQVARNA AB, Huskvarna (SE)

(72) Inventor: Tommy Olsson, Lerum (SE)

(21) Appl. No.: 18/027,433

(22) PCT Filed: Sep. 13, 2021
(86) PCT No.: PCT/SE2021/050874

§ 371 Date: Mar. 21, 2023

(30) Foreign Application Priority Data
Sep. 24, 2020 (SE) 2051115-0

(51) Int. Cl. E02F 9/20; E02F 3/96; E02F 9/26

(52) U.S. Cl. CPC E02F 9/205; E02F 3/964; E02F 9/268

(57) ABSTRACT

A control device for controlling one or more actuators (110, 120, 130, 140) on a construction machine (100), the control device comprising a control input arrangement configured to receive a manual control command from an operator for controlling the one or more actuators, and to output a coordinate indicative of the manual control command as function of time, the control device further comprising a processing unit arranged to determine a first time derivative of the coordinate, and a transmitter arranged to transmit the coordinate and the first time derivative of the coordinate to an actuator control unit of the construction machine, thereby enabling compensation for time delay between the control device and the construction machine by the actuator control unit, wherein the time delay T to be compensated for is based on a pre-determined calibration setting.

### TECHNICAL FIELD

The present disclosure relates to construction machines such as remotely controlled demolition robots, excavators, and the like. There are disclosed actuator control units, remote controls, construction machines and methods which provide machine actuator handling with a perceived reduced latency.

### BACKGROUND

Many types of construction machines, such as remote-controlled demolition machines and excavators are controlled by an operator using joysticks or other manual control input arrangements. The control input arrangements may, e.g., be arranged in a cabin on the machine or on a remote control connected to the machine via wireless link.

It is important that the actuator latency, i.e., the delay measured from the time instant a control command is given to the corresponding response by the actuator, is kept at a minimum. Too large control latencies hamper machine handling in general and may limit the accuracy with which the operator can use the machine. Also, too much latency may result in that an operator over-steers an actuator which is undesired.

US 2011/0087371 A1 discusses problems related to latency in joystick-based control systems for robots. The presented solution relies on simulating motion of the robot locally, such that the user perceives that the robot is nearly perfectly responsive, which reduces over-steering issues.

US 2015/0120048 A1 also relates to problems with delay on control links for controlling robots. Here, delay problems are alleviated by selectively transforming a received user robot command based on current and previous robot poses. The actuator response to a given command is determined based on the robot pose seen by the operator (with delay) when issuing the command. This way actuator control accuracy can be improved.

US 2005/0125150 A1 relates to real time control of hardware and software over a communications network. The proposed technique involves a time synchronization between transmitter and receiver, and a prediction of control commands forward in time to account for delays over the communications link.

US 2019/0332918 A1 discloses a wireless feedback control system which implements a neural network which has been trained to predict a future state of a target system. The predicted future state is used to determine a control signal. Time stamps are used to synchronize the controller side and the actuator side of the system. The disclosed system can be used to compensate for a delay incurred over a communications link between a transmitter and a receiver. Nevertheless, there is a continuing need for improved actuator controls.

### SUMMARY

It is an object of the present disclosure to provide methods and devices for improved construction machine handling. This object is at least in part obtained by a control device for controlling one or more actuators on a construction machine. The control device comprises a control input arrangement configured to receive a manual control command from an operator for controlling the one or more actuators, and to output a coordinate s(t), x(t) indicative of the manual control command as function of time t. The control device further comprises a processing unit arranged to determine a first time derivative v(t) of the coordinate x(t), and a transmitter arranged to transmit a data signal indicative of the coordinate x(t) and the first time derivative v(t) of the coordinate x(t) to an actuator control unit of the construction machine, thereby enabling compensation for a time delay T between the control device and the construction machine by the actuator control unit. Based on the coordinate and the first time derivative, a prediction of a future coordinate can be made. Thus, if a delayed coordinate is received, a prediction of a current control command coordinate can be made. Thus, an operator of the machine will experience a reduced delay when handling the machine, or even a zero delay. The transmission delay between the control device and the machine is still there, but due to the prediction this delay is hidden from the operator. This improves handling and reduces issues such as oversteering and reduced control accuracy.

According to aspects, the processing unit is arranged to determine a second time derivative a(t) of the coordinate x(t), and the transmitter (330) is arranged to also transmit a data signal indicative of the second time derivative of the coordinate a(t) to the actuator control unit. The second time derivative provides even more information which enables a more accurate compensation for the time delay T between the control device and the construction machine by the actuator control unit.

According to aspects, the control input arrangement comprises any of one or more joysticks, one or more touch screens, one or more gesture control input gloves, and one or more haptic control input gloves. Thus, the techniques disclosed herein a versatile in that they can be employed with a wide variety of input devices. The control device may for instance be a remote control device for controlling a construction machine over a wireless link, and the transmitter is then normally a radio frequency transmitter arranged to transmit a wireless signal to an actuator control unit on the construction machine. However, the control device can also be an in-cabin or an on-machine control device for controlling the construction machine over a wired communication interface, in which case the transmitter is arranged to transmit a data signal to the actuator control unit of the construction machine over the wired communication interface. Thus, the devices disclosed herein can be used both with remote controls and in-cabin controls, or a combination of the two. Advantageously, the delay which is compensated for by prediction can be adjusted for a specific control device. Thus, the delay compensated for when using the wireless device may be longer than the delay compensated for when using the wired controls. However, due to the difference in delay compensation, the handling feel will be similar for the two different controls when used to control, e.g., the same robot or devices of the same type.

According to aspects, the control device is arranged to obtain a finite length sequence of coordinates s(t), x(t) as function of time t, and also a pre-determined set of motion models indicating respective motion patterns of the control input arrangement. The processing unit can then be arranged to select a motion model out of the set of motion models which matches the sequence of coordinates based on a pre-determined matching criterion, and the transmitter can be arranged to transmit data indicating the selected motion model to the actuator control unit. By communicating a motion model which matches the motion of the control inputs of an operator, the prediction can be refined. For instance, if the operator moves a joystick along an arcuate path, then the prediction can be made in the extension of this arcuate path instead of along a straight line, which improves the prediction performance.

The object is also obtained by a control device for controlling one or more actuators on a construction machine. The control device comprises a control input arrangement configured to receive a manual control command from an operator for controlling the one or more actuators and to output a coordinate s(t), x(t) indicative of the control command as function of time t. The control device also comprises a processing unit arranged to determine a first time derivative v(t) of the coordinate, and to predict a future coordinate value x(t+T) indicating a future manual control command based on the coordinate s(t), x(t) and on the first time derivative v(t), and a transmitter arranged to transmit a data signal indicative of the future coordinate value x(t+T) to the construction machine, thereby compensating for time delay T between the control device and the construction machine. This control device performs a prediction to compensate for a future delay which is about to be incurred. Thus, when the data signal arrives at a receiving end after the time delay T, this delay has already been compensated for. An operator will therefore experience a reduced delay compared to a system which does not perform the prediction of the future coordinate value.

There is furthermore disclosed herein an actuator control unit for controlling one or more actuators on a construction machine. The actuator control unit is arranged to receive a data signal comprising a delayed manual control command input by an operator for controlling the one or more actuators and also comprising a first time derivative v(t−T) of the delayed manual control command. The actuator control unit is configured to predict a coordinate value x(t) indicative of a current manual control command input by the operator based on the data signal comprising the delayed manual control command and the first time derivative v(t−T). The actuator control unit is also configured to generate a control command c(t) for controlling the one or more actuators based on the predicted coordinate value x(t), thereby compensating for a time delay T between the control device and the actuator control unit. Thus, a delayed coordinate is received which would affect handling of the construction machine in a negative way. However, a prediction of a current control command coordinate is made based on the received data signal comprising the delayed command and its first time derivative. Thus, as mentioned above, an operator of the machine will experience a reduced delay when handling the machine, or even a zero delay. This improves handling and reduces issues such as oversteering and reduced control accuracy.

According to aspects, the control unit is further arranged to receive a data signal comprising a second time derivative a(t−T) of the delayed manual control command, and the actuator control unit is configured to predict the coordinate value x(t) indicative of the current manual control command input by the operator based also on the second time derivative a(t−T) of the delayed manual control command. This improves the prediction, which is an advantage since handling is then further improved.

According to aspects, the actuator control unit is configured to adjust a delay value T to be compensated for by the coordinate value prediction based on a calibration setting. This calibration setting can be used to adjust the prediction to different types of machines with different delays. The calibration setting can also be used to adjust the prediction to a personal preference of a given operator. Some operators may not mind a delay too much, perhaps since they are used to some delay when handling construction machines via remote control, while other operators may prefer to minimize delay as far as possible.

According to aspects, the actuator control unit is arranged to determine a prediction error by comparing the predicted coordinate value x(t) to a corresponding future coordinate value, and to adjust the delay value T to be compensated for by the coordinate value prediction based on a magnitude of the prediction error, such that a small error results in a longer delay value T to be compensated for compared to a larger error. Thus, the prediction time horizon can be maximized conditioned on, e.g., a maximum allowable prediction error. If the prediction error increases then the prediction time horizon can be reduced automatically, and vice versa, which is an advantage.

According to aspects, the actuator control unit is configured to predict the coordinate value x(t) indicative of a current control command by the operator in dependence of the control command, wherein the actuator control unit is configured to associate a delay T to be compensated for by the predicted coordinate value x(t) in dependence of the control command. It is appreciated that certain control commands are associated with different delays compared to other commands, perhaps involving a different set of actuators. However, the actuator control unit may account for such differences by adjusting the prediction time horizon to match the current command. This improves prediction accuracy, which is an advantage.

According to aspects, the actuator control unit is configured to predict the coordinate value x(t) based on any of a PID regulator algorithm, a Kalman filter algorithm and/or a sequential minimum mean-squared error (MMSE) algorithm. These are relatively low complexity algorithms which can be implemented efficiently on a small size processing circuit in a cost effective manner, which is an advantage.

The actuator control unit may also be configured to predict the coordinate value x(t) based on a neural network trained on training data comprising a first and a second sequence of coordinate values where the second sequence of coordinate values is a delayed version of the first sequence, and where the delay corresponds to the time delay between a control device and the actuator control unit. This implementation may be slightly more complex compared to, e.g., a Kalman filter implementation, but the performance can often be superior, at least in some scenarios. The neural network may for instance be configured to be trained for a given operator or group of operators. This brings the additional advantage of being able to customize the delay prediction for a certain individual or group of individuals, which is an advantage.

According to aspects, the neural network comprises a long short-term memory (LSTM) artificial recurrent neural network architecture. The LSTM architecture has proven particularly suitable for this type of processing.

According to aspects, the actuator control unit is arranged to receive a data signal comprising a sequence of control command coordinates associated with a coordinate update rate. The actuator control unit can then be configured to predict the coordinate value x(t) at a rate above the coordinate update rate, and/or to generate the control command c(t) for controlling the one or more actuators at a control update rate above the coordinate update rate. This way a more smooth control command over time can be sent to the actuators, which improved handling of the construction machine and may also prolong lifetime of the actuators, since jerky control commands are avoided by the more smooth higher sample rate control signals.

There are also disclosed herein construction machines, actuator control units, controllers, processing circuits, computer programs, computer program products as well as methods associated with the advantages mentioned above.

Generally, all terms used in the claims are to be interpreted according to their ordinary meaning in the technical field, unless explicitly defined otherwise herein. All references to “a/an/the element, apparatus, component, means, step, etc.” are to be interpreted openly as referring to at least one instance of the element, apparatus, component, means, step, etc., unless explicitly stated otherwise. The steps of any method disclosed herein do not have to be performed in the exact order disclosed, unless explicitly stated. Further features of, and advantages with, the present invention will become apparent when studying the appended claims and the following description. The skilled person realizes that different features of the present invention may be combined to create embodiments other than those described in the following, without departing from the scope of the present invention.

### BRIEF DESCRIPTION OF THE DRAWINGS

The present disclosure will now be described in more detail with reference to the appended drawings, where

FIG. 1 shows an example demolition robot;

FIG. 2 shows an example remote control device;

FIG. 3 schematically illustrates processing in a remote control;

FIG. 4 illustrates an example remote control radio signal format;

FIG. 5 schematically illustrates processing in a construction machine;

FIG. 6 schematically illustrates processing in a remote control;

FIG. 7 illustrates an example remote control radio signal;

FIG. 8 shows an example remote control device;

FIGS. 9A,9B are flow charts illustrating methods;

FIG. 10 schematically illustrates a control unit; and

FIG. 11 schematically illustrates a computer program product.

### DETAILED DESCRIPTION

The invention will now be described more fully hereinafter with reference to the accompanying drawings, in which certain aspects of the invention are shown. This invention may, however, be embodied in many different forms and should not be construed as limited to the embodiments and aspects set forth herein; rather, these embodiments are provided by way of example so that this disclosure will be thorough and complete, and will fully convey the scope of the invention to those skilled in the art. Like numbers refer to like elements throughout the description.

It is to be understood that the present invention is not limited to the embodiments described herein and illustrated in the drawings; rather, the skilled person will recognize that many changes and modifications may be made within the scope of the appended claims.

The present disclosure relates to controlling one or more actuators on a construction machine, such as a boom or stick motion, a body swing, and/or caterpillar tracks or drive wheel motion. The present disclosure also relates to controlling various construction tools which can be mounted on the construction machine, such as hammers, and the like mounted on the arm of a demolition robot. It is appreciated that the control arrangements and methods disclosed herein can be used with advantage in demolition robots, and in particular in remote controlled demolition robots. However, many of the techniques discussed herein are also applicable in other types of construction machines, such as excavators and the like.

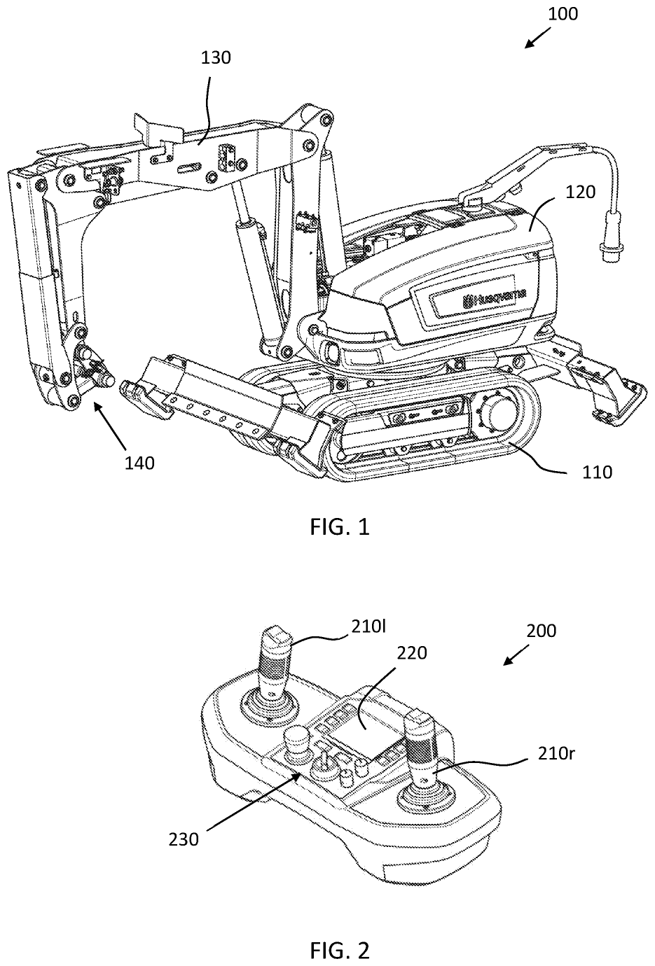

FIG. 1 illustrates a remote controlled demolition robot, which is an example of a construction machine 100. The demolition robot comprises tracks 110 for propelling the robot over ground. A body 120 is rotatably mounted on the bottom section which comprises the tracks. An arm 130 extends from the body 120. Various tools, such as pneumatic or hydraulic hammers and the like can be carried by the arm 140. These actuators are arranged to be controlled by a control device comprising a control input arrangement configured to receive a manual control command from an operator. Example control input devices may be, e.g., levers, joysticks, touch screens or even haptic gloves and the like. The control input device is configured to output a coordinate indicative of the manual control command as function of time. For instance, the position of a joystick can be defined as a position in a two-dimensional coordinate system, and the location of a finger on a touch screen can also be defined in terms of a two-dimensional coordinate. A lever is well represented by a one-dimensional coordinate, while haptic gloves require three dimensional coordinates to be represented.

FIG. 2 illustrates an example control device 200 in the form of a wireless remote control. The control device 200 comprises left and right joysticks 210l, 210r, a display for communicating information to an operator, and a plurality of buttons and levers 230 for controlling various functions on the construction machine 100. The remote control device 200 is configured to communicate with the construction machine 100 via wireless radio link, such as a Bluetooth link, a wireless local area network (WLAN) radio link, or a cellular connection link, such as the cellular access network links defined by the third generation partnership program (3GPP), i.e., 4G, 5G and so on.

A problem with construction equipment 100 such as remote controlled demolition robots is the delay from the time instant a control command is input by the operator to the time instant the actuator responds to the control command. If an operator of the wireless remote control 200 moves the left joystick upwards to lift the arm 130, there will be a small delay before the actuator arranged to control arm position responds to the control command and starts to move the arm. This delay is normally on the order of 100-200 ms. One part of this delay is incurred by the wireless communication link. Some links transmit data packets every 50 ms or so, and there is some additional delay incurred by various processing and queuing steps on the way between the control device and the actuator. Another part of the delay is caused by mechanical effects in the system such as delays in hydraulic valve actuators, mechanical linkage, and the like.

The present disclosure presents a way to reduce the perceived delay between control command input and actuator response. The idea relies on determining not only the coordinate of the control input arrangement, but also a time derivative of the coordinate. This can, for instance, be achieved by oversampling the position of a control input arrangement such as a joystick in relation to the transmission rate of the wireless link. Then, using the coordinate and the time derivative of the coordinate, a prediction can be made for a future position of the control input arrangement.

To exemplify, suppose that the coordinate of a joystick at time t is x(t), and that the delay between the joystick and the actuator control unit is about T=75 ms. This means that the control command is received at the actuator control unit after a T second delay, i.e., x(t−T). However, if also v(t−T) is available at the actuator control unit, the delay can at least partly be compensated for by making a prediction of the current coordinate of the control input device based on the delayed coordinate, and controlling the actuator based on this coordinate instead of the delayed one, i.e., x(t−T)+Tv(t−T). If the joystick was moved in a straight line with constant velocity, the prediction will be close to perfect, and the operator will perceive almost no delay from control input to actuator response. More advanced prediction methods will be discussed in detail below.

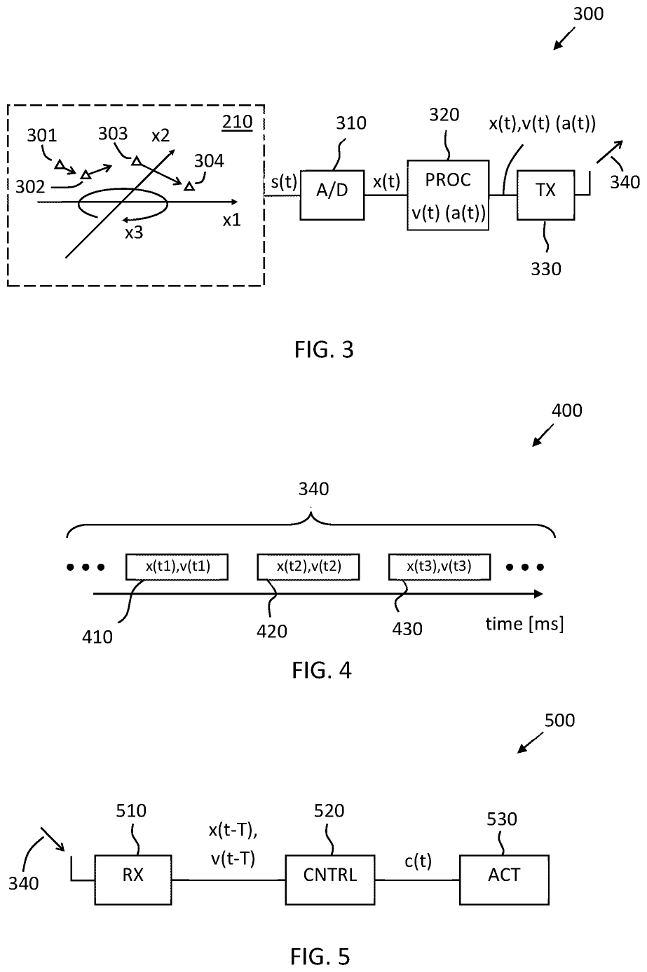

FIG. 3 schematically illustrates a control device 300 for controlling one or more actuators 110, 120, 130, 140 on a construction machine 100 according to the above principles.

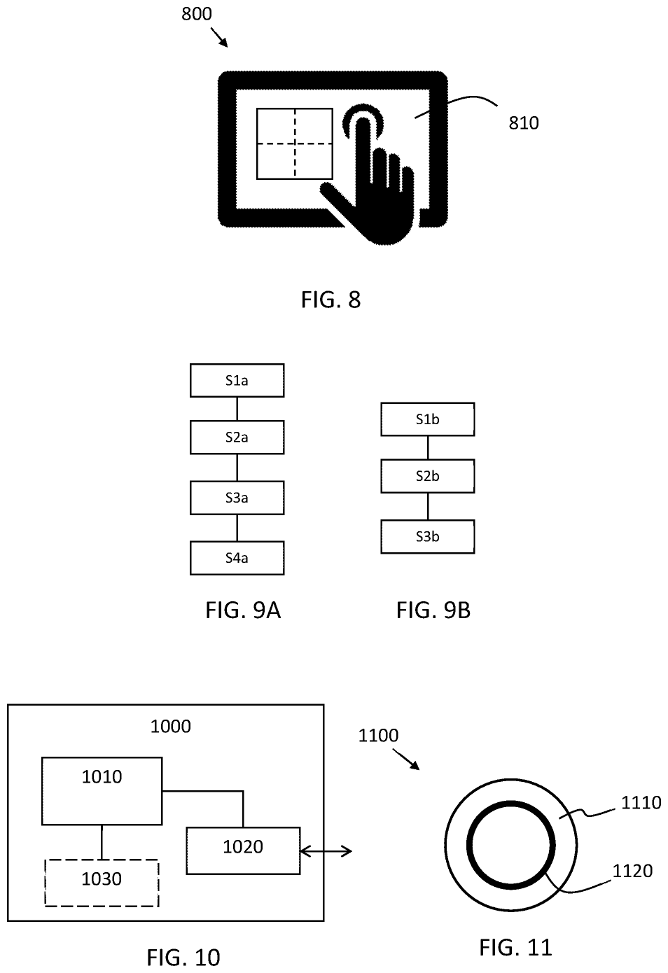

The control device 300 comprises a control input arrangement 210 configured to receive a manual control command from an operator for controlling the one or more actuators, and to output a coordinate indicative of the manual control command as function of time t. The control input arrangement 210 may be a one-dimensional control device such as a lever or knob, or a two-dimensional control device such as a joystick 210l, 210r shown in FIG. 2, or a touchscreen sensor 810 as illustrated in FIG. 8. There are also three-dimensional control input devices, such as a joystick allowing the stick to be turned as a knob, or haptic gloves which may be moved freely in three-dimensional space. A one-dimensional coordinate is just a scalar, while a two-dimensional coordinate can be represented as a vector [x1, x2] with two elements. A three-dimensional coordinate can be represented as a three-element vector [x1,x2,x3]. The position of the control input device at each point in time can be defined by a coordinate x(t). This coordinate is often a sample taken by an analog to digital converter (A/D) 310 of an analog signal s(t). A sequence of coordinates 301, 302, 303 then illustrates how an operator has moved the control input arrangement.

The control devices 200, 300, 800 disclosed herein further comprises a processing unit 320 arranged to determine a first time derivative v(t) of the coordinate x(t). This means that the processing unit generates a measure of how the control input arrangement was moving at the time of the sample x(t). This can be seen as the velocity associated with the control input device at time t. The time derivative may be determined by differentiating the path followed by the control input device with respect to time, or as a difference operation performed on a sequence of coordinate values. Some control input devices may be configured to output an analog velocity signal in addition to the coordinate signal s(t). It is appreciated that the present disclosure encompasses all such methods of generating the first time derivative v(t).

One straight forward method of generating the first time derivative is o simply oversample the coordinate signal to obtain a sequence of coordinate values, and then apply a difference operation to the sampled coordinate values, which difference operation results in values of the first time derivative. Thus, if the transmitter 330 is arranged to transmit data 340 to the actuator control unit 520 at a transmission rate, such as one every 50 ms, the control device can be arranged to sample the coordinate s(t), x(t) at a rate exceeding the transmission rate, and to determine the first and/or the second time derivative based on a time difference of sampled coordinate values.

FIG. 4 illustrates an example radio transmission format 400 according to which the data signal 340 may be formatted, where the coordinate data and the first time derivative data is transmitted in packets 410, 420, 430 with a certain repetition interval. This repetition interval may be on the order of 50 ms, which means that new coordinate information reaches the actuator controller every 50 ms. The data packets normally also comprise headers and other data fields, but such data structures are known and will therefore not be discussed in more detail herein.

The control device also comprises a transmitter 330 arranged to transmit the coordinate x(t) and also the first time derivative v(t) of the coordinate x(t) as a data signal 340 to an actuator control unit 520 of the construction machine 100, thereby enabling compensation for time delay T between the control device and the construction machine by the actuator control unit 520.

According to some aspects, the control device is a remote control device 200 for controlling a construction machine 100 over a wireless link. The transmitter 330 is then a radio frequency transmitter arranged to transmit the data signal 340 as a wireless signal to an actuator control unit on the construction machine 100.

According to some other aspects, the control device is an in-cabin or an on-machine control device for controlling the construction machine over a wired communication interface. The transmitter 330 is then arranged to transmit the data signal 340 as a wireline signal to the actuator control unit of the construction machine over the wired communication interface.

It is appreciated that both wired and wireless control links are associated with signal delay, although the signal delays incurred by a wired interface are normally smaller compared to a wireless radio interface. Advantageously, the delay which is compensated for by prediction can be adjusted for a specific control device, i.e., calibrated such that the delays are the same for each of a plurality of control devices configured to control a given construction machine. Thus, the delay compensated for when using a wireless device control unit may be longer than the delay compensated for when using wired controls. However, due to the difference in delay compensation, the handling feel will be similar for the two different controls when used to control, e.g., the same robot or devices of the same type.

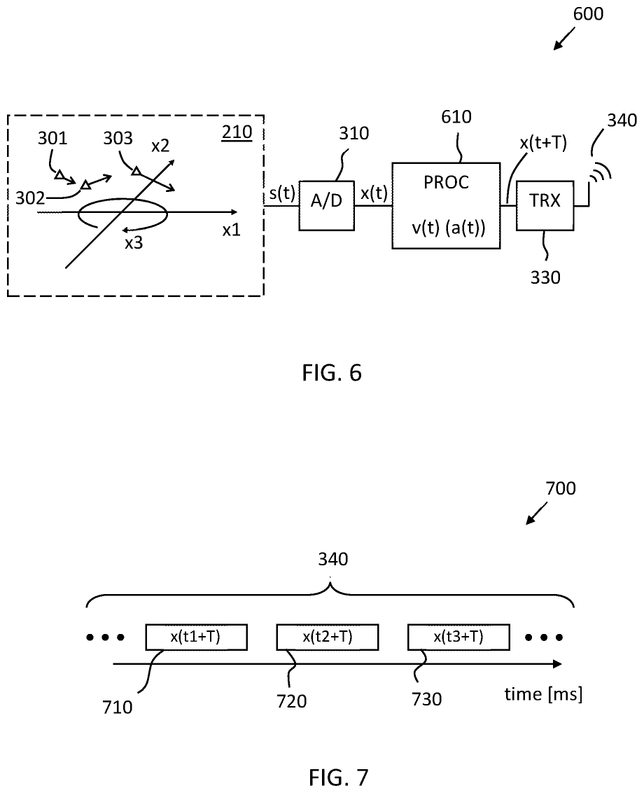

Various methods of compensating for the delay between control unit and actuator control unit based on the coordinate and on the first time derivative will be discussed in more detail below. It is appreciated that this compensation operation can be performed at the construction machine or at the control device with equal effect. An example of where the compensation is instead performed at the control device prior to transmitting the signal to the construction machine 100 will be discussed in more detail below in connection to FIG. 6.

According to some aspects, the processing unit 320 is also arranged to determine a second time derivative a(t) of the coordinate x(t), in which case the transmitter 330 is arranged to also transmit the second time derivative of the coordinate to the actuator control unit 520. This second time derivative can be seen as an acceleration of the coordinate motion along the path. For instance, assuming that the acceleration is close to constant over the delay period T, a predicted coordinate which tries to compensate for a delay of T seconds is then x(t−T)+Tv(t−T)+0.5T²a(t−T). Again, the second time derivative can be determined by differentiating the first time derivative once more with respect to time, e.g., by performing a difference operation on a sequence of velocity values.

It is appreciated that both the first and the second time derivative can be communicated as unitless proprietary values, such as unitless values on a scale from 0-10, where 0 represents a small or non-existent derivative and 10 represents a large derivative.

The time derivative normally has the same dimensionality as the coordinate, i.e., for a two-dimensional control input arrangement such as a joystick, the velocity v(t) also has two components, i.e., a two-dimensional vector, whereas a lever with a scalar coordinate also has a one-dimensional time derivative.

A motion model is a model which describes characteristics of the motion of an object. Motion models can be used by signal processing algorithms to track moving objects with increased accuracy. This is because an additional amount of measurement noise can be suppressed if the target object is known to abide by a given motion model. Commonly used motion models comprise the constant velocity motion model where the target object is assumed to move with an approximately constant velocity in some direction, the constant acceleration motion model where the target object is assumed to move with constant acceleration in some direction, and the constant turn rate motion model where the object is assumed to execute a turning maneuver with some radial velocity.

Suppose for one of the joysticks 210l, 210r in the remote control 200, that the current input command is represented as a coordinate in two dimensions,

$$x = [ \begin{matrix}{x}_{1} \\ {x}_{2}\end{matrix} ]$$

Of course, both joysticks can also be considered simultaneously, in which case the input command is a four-dimensional input command.

A Brownian motion model which basically assumes a random motion about the center coordinate, is then given by the transition matrix

$$F = [ \begin{matrix}10 \\ 01\end{matrix} ] ,$$

such that a one-step predicted coordinate is

$$x ( t + T ) = F [ \begin{matrix}{x}_{1} ( t ) \\ {x}_{2} ( t )\end{matrix} ] ,$$

i.e., the same position.

A constant velocity motion model is instead defined by the transition matrix

$$F = [ \begin{matrix}1 & 0 & T & 0 \\ 0 & 1 & 0 & T \\ 0 & 0 & 1 & 0 \\ 0 & 0 & 0 & 1\end{matrix} ] ,$$

such that

$$x ( t + T ) = F [ \begin{matrix}{x}_{1} ( t ) \\ {x}_{2} ( t ) \\ {v}_{1} ( t ) \\ {v}_{2} ( t )\end{matrix} ]$$

is now translated a distance depending on the velocity v(t) in the two dimensions.

A constant acceleration motion model is given by the transition matrix

$$f = [ \begin{matrix}1 & 0 & T & 0 & \frac{{T}^{2}}{2} & 0 \\ 0 & 1 & 0 & T & 0 & \frac{{T}^{2}}{2} \\ 0 & 0 & 1 & 0 & T & 0 \\ 0 & 0 & 0 & 1 & 0 & T \\ 0 & 0 & 0 & 0 & 1 & 0 \\ 0 & 0 & 0 & 0 & 0 & 1\end{matrix} ] ,$$

such that

$$x ( t + T ) = F [ \begin{matrix}{x}_{1} ( t ) \\ {x}_{2} ( t ) \\ {v}_{1} ( t ) \\ {v}_{2} ( t ) \\ {a}_{1} ( t ) \\ {a}_{2} ( t )\end{matrix} ]$$

is now translated a distance depending on the velocity v(t) and on the acceleration. Other motion models include constant turn rate motion and motion along some predetermined track. Motion models and their use in tracking are generally known and will therefore not be discussed in more detail herein.

Knowing which motion model to use often simplifies tracking the motion of, e.g., a control input device such as the joysticks 210l, 210r, or the touch screen sensor 810.

According to some aspects, the control device is arranged to obtain a finite length sequence of coordinates, i.e., a sequence over time t of s(t) and/or x(t), and also a pre-determined set of motion models indicating respective motion patterns of the control input arrangement. The processing unit 320 can then be arranged to select a motion model out of the set of motion models which matches the sequence of coordinates based on a pre-determined matching criterion, and the transmitter 330 can then transmit data indicating the selected motion model to the actuator control unit. The matching between the sequence and the motion models may, for instance, be done by comparing the velocity, acceleration, and turn rate over the sequence to see which one remains the most constant. The matching between the sequence and the different motion models may also be done by computing a least-squares fit of the sequence to the different models and selecting the model which exhibits the best fit.

This type of operation can also be implemented in the actuator control arrangement. For instance, the actuator control unit 520 can be arranged to obtain a finite length sequence of coordinates s(t), x(t) as function of time t, and also a pre-determined set of motion models indicating respective motion patterns of the control input arrangement. The actuator control unit 520 can further be arranged to select a motion model out of the set of motion models which matches the sequence of coordinates based on a pre-determined matching criterion, and to predict the coordinate value x(t) indicative of the current manual control command based on the selected motion model. The prediction can, e.g., be based on Kalman filtering using several Kalman filters, where each Kalman filter implements a given motion model. Multiple hypotheses can then be maintained and selected from based on some performance criterion. This type of multiple hypothesis testing (MHT) is known and will therefore not be discussed in more detail herein.

FIG. 5 shows an actuator control arrangement 500 configured to control one or more actuators 530. The control arrangement 500 may, e.g., be implemented as a module comprised on a construction machine computer board of the construction machine 100. The control arrangement is arranged to receive the data signal 340 by a receiver 510, which receiver forwards the received data signal 340 to an actuator control unit 520. Note that the received data signal 340 comprises the coordinate and the first time derivative of the coordinate as discussed above, and optionally also the second time derivative. Due to the transmission delay and other effects the coordinate data and the first time derivative data is delayed by a period T, which may be on the order of tens of ms, i.e., around 50 ms or so in certain systems. The actuator control unit 520 is arranged to control one or more actuators on the construction machine 100 by generating respective control signals c(t).

The actuator control unit 520 is arranged to receive a data signal 340 indicative of a delayed manual control command input by an operator for controlling the one or more actuators 110, 120, 130, 140 and also indicative of a first time derivative v(t−T) of the delayed manual control command. This received control information indicates what the operator input using the control input arrangement on the control device. However, due to the delays incurred by the system, the received command corresponds to what the operator input T seconds ago. In other words, a received coordinate x(t−T) is actually a coordinate of a control command sampled T seconds ago. This delay hampers accuracy and may lead to over-steering. To compensate for the delay T, the actuator control unit 520 is configured to predict a coordinate value x(t) indicative of a current manual control command input by the operator based on the data signal 340 which comprises information related to both the delayed manual control command and how that delayed control command was changing at the time it was captured, i.e., its first time derivative v(t−T).

A prediction horizon corresponds to the time predicted forward in time from a time stamp of the coordinate. Thus, if a manual control command such as a joystick position coordinate was sampled at the control input arrangement at time t=0 s and used to predict a future manual control command, such as a future joystick position coordinate, for the coordinate at time t=0.1 s, then the prediction time horizon is 0.1 s. It is appreciated that the longer the time horizon is, the worse the accuracy of the prediction. Coordinate values can normally be predicted with high accuracy as long as the prediction time horizon is not large enough, but after a point the accuracy of the predictions start to deteriorate.

The actuator control unit 520 is configured to generate a control command c(t) for controlling the one or more actuators 110, 120, 130, 140 based on the predicted coordinate value, thereby compensating for a time delay T between the control device and the actuator control unit 520. Thus, by predicting a coordinate value based on the received delayed coordinate value and on the first time derivative, the delay perceived by the operator can be reduced.

The prediction time horizon can be selected smaller than the actual delay from the control input arrangement to the actuator control unit, in which case some delay will remain. However, this small remaining delay may be acceptable and perhaps even not noticeable by an operator.

The prediction time horizon can also be selected larger than the delay incurred by the transmission of the data signal 340. In this case delays incurred by mechanical components can also be absorbed, such as delays associated with controlling hydraulic valves, mechanical links, and general mechanical inertia. For instance, if the prediction time horizon is selected to be on the order of 150 ms, most of the total delay in a demolition robot control system will be perceived as removed by an operator of the robot.

Generally, at least some of the actuator control units 520 discussed herein may be arranged to receive the delayed coordinate x(t−T) or delayed manual control command as part of a sequence of control commands associated with a control command update rate R1. As mentioned above, this update rate R1 may be on the order of 1/60 ms⁻¹ or 1/50 ms⁻¹, i.e., quite slow compared to the processing rate of most modern processors. The actuator control unit 520 can be configured in a straight forward manner to predict the coordinate value x(t) at a rate R2 well above the coordinate update rate, such as at a rate R2 of ⅕ ms⁻¹ or even faster, and/or to generate the control command c(t) for controlling the one or more actuators 110, 120, 130, 140 at a control update rate R3 above the coordinate update rate R1, such as at a rate R3 of ⅕ ms⁻¹ or so. By interpolating between the predicted coordinates to generate a higher rate prediction signal and/or a higher rate control signal, a more smooth control command sequence can be fed to the actuators, which may result in a more controlled behavior of the construction machine.

The prediction accuracy can in some scenarios be improved by considering a sequence of coordinates instead of just the last received coordinate and the corresponding time derivative. If a sequence of past coordinates is available, different polynomial fit methods and the like can be used to refine the prediction. For instance, a fixed degree polynomial can be fit to the sequence of coordinates and used to generate the predicted coordinate.

Optionally, the control unit 520 is further arranged to receive a data signal 340 indicative of a second time derivative of the manual control command a(t−T), in which case the actuator control unit 520 can be configured to predict the coordinate value x(t) indicative of the current manual control command input by the operator based also on the second time derivative a(t−T). The acceleration can be used to refine the prediction of the coordinate as explained above.

It is appreciated that the inventive concepts discussed herein may also be practiced without access to the first and/or second time derivatives. Consider a sequence of coordinate values {x₁, x₂, x₃}. This sequence may be used in an extrapolation operation in order to predict a future coordinate xN at a time corresponding to the prediction time horizon without implicit knowledge of any time derivatives. Thus, there is also disclosed herein an actuator control unit 520 for controlling one or more actuators 110, 120, 130, 140 on a construction machine 100, wherein the actuator control unit 520 is arranged to receive a sequence of coordinates indicative of a delayed manual control command input sequence by an operator for controlling the one or more actuators 110, 120, 130, 140, wherein the actuator control unit 520 is configured to predict a coordinate value x(t) indicative of a current manual control command input by the operator based on an extrapolated value of the received sequence of coordinates, and wherein the actuator control unit 520 is configured to generate a control command c(t) for controlling the one or more actuators 110, 120, 130, 140 based on the predicted coordinate value, thereby compensating for a time delay T between the control device and the actuator control unit 520.

Of course, the actuator control unit 520 can optionally also be configured to determine a first time derivative v(t) and/or a second time derivative a(t) associated with the manual control commands input by the operator based on the received sequence of coordinates. This first and/or second time derivative can be determined in a straight forward manner by differentiating the extrapolated sequence.

It is appreciated that the prediction operations discussed above can also be performed at least in part on the control device side, i.e., by the control input device used by the operator to generate the data signal 340. In this case the control device predicts a future control command x(t+T) based on the current operating command x(t) input by the operator. It is also possible to perform one part of the prediction at the control device side and the remaining part of the prediction at the actuator control unit side.

FIG. 6 shows a control device 600 for controlling one or more actuators 110, 120, 130, 140 on a construction machine 100. The control device comprises a control input arrangement 210, such as a joystick, a touch screen or a haptic glove arrangement configured to receive a manual control command from an operator for controlling the one or more actuators and to output a coordinate s(t), x(t) indicative of the control command as function of time t. A processing unit 610 is arranged to determine a first time derivative v(t) of the coordinate v(t), and to predict a future coordinate value x(t+T) indicating a future manual control command based on the coordinate s(t), x(t) and on the first time derivative v(t). A transmitter 330 is arranged to transmit the future coordinate value x(t+T) to the construction machine 100, thereby compensating for time delay T between the control device and the construction machine. Thus, advantageously, the control device applies a delay compensation before the delay occurs. This is an advantage since the control device can be used with legacy construction equipment which does not comprise an actuator control unit configured to compensate for delay based on the coordinate and on the first time derivative.

FIG. 7 illustrates an example radio transmission format 400 according to which a data signal 340 may be formatted, where the predicted coordinate data is transmitted in packets 710, 720, 730 with a certain repetition interval. This repetition interval may be on the order of 50 ms, which means that new coordinate information reaches the actuator controller every 50 ms. Optionally, the current coordinate value may be transmitted as part of the data signal 340. This current coordinate value can be used at the receiving end to, e.g., estimate the prediction error. Of course, the prediction error, or some statistic thereof can be sent via the data signal 340 instead of or as a complement to the current coordinate data.

As discussed above, the prediction time horizon is likely to have an impact on prediction error. The longer ahead in time the system tried to predict the coordinate the larger the prediction error is likely to become. According to some aspects, the actuator control unit 520 is configured to adjust a delay value T to be compensated for by the coordinate value prediction based on a calibration setting. This calibration setting may either be fixedly configured when the construction equipment leaves the factory, or dynamically adjusted by the operator, perhaps by operating a control 230 on the control device. This way an operator may adjust the prediction time horizon to adjust the trade-off between prediction error and control delay to a level which suits the operator. It is appreciated that this preference may be personal. Thus, one operator may prefer to minimize prediction error by selecting a small prediction time horizon, while another operator may be more sensitive to large control delays and therefore configure a larger prediction time horizon.

The current prediction error is possible to determine in real time, simply by comparing predicted coordinate values to coordinate values obtained after a delay corresponding to the prediction time horizon. A statistic of the prediction error, e.g., a means-squared error (MSE) or a time windowed MSE can be used to maximize the prediction time horizon in real time while keeping the prediction error below some threshold value, which may be a fixed threshold value or a configurable threshold value. Consequently, the actuator control unit 520 is optionally arranged to determine a prediction error by comparing the predicted coordinate value x(t) to a corresponding future coordinate value, and to adjust the delay value T to be compensated for by the coordinate value prediction based on a magnitude of the prediction error, such that a small error results in a longer delay value T to be compensated for compared to a larger error. Interestingly, this way of adjusting the prediction time horizon dynamically implies that the prediction time horizon will vary in dependence of how the construction machine is used. If the operator uses the machine in poses where it is difficult to accurate predict the future coordinate value based on the first and optionally also second time derivative, then the prediction time horizon will be automatically adjusted to account for the larger prediction error.

To prevent the prediction time horizon from going beyond the actual total delay incurred by the control system, a maximum prediction time horizon can be configured. This maximum prediction time horizon may be on the order of 150-200 ms.

It is appreciated that, although the delay incurred by the communication of the data signal 340 is more or less constant regardless of how the construction machine 100 is used, the mechanical delay may vary in dependence of machine pose and/or in dependence of which tool is used or which operation is to be performed. For instance, moving the arm 130 of a demolition robot may be associated with less delay compared to moving a demolition robot forward by engaging the tracks 110. To account for such differences in delay between different commands, the actuator control unit 520 can be configured to predict the coordinate value x(t) indicative of a current control command by the operator in dependence of the control command. The actuator control unit 520 can for instance be configured to associate a delay T to be compensated for by the predicted coordinate value x(t) in dependence of the control command. The different prediction time horizons to use for different types of control commands and for different types of operations, or for different operating scenarios can be stored in a database on-board the construction machine or at a remote server accessible from the construction machine.

Several different algorithms can be used for the actual prediction based on the delayed coordinate value and on the first and optionally also second time derivative.

For instance, the actuator control unit 520 can be configured to predict the coordinate value x(t) based on a PID regulator algorithm. A PID regulator has three parts, terms P, I and D: Term P is proportional to the current value of the error e(t). For example, if the error is large and positive, the control output will be proportionately large and positive, taking into account the gain factor. Using proportional control alone will result in an error between the setpoint and the actual process value, because it requires an error to generate the proportional response. If there is no error, there is no corrective response.

Term I accounts for past values of the error and integrates them over time to produce the I term. For example, if there is a residual error after the application of proportional control, the integral term seeks to eliminate the residual error by adding a control effect due to the historic cumulative value of the error. When the error is eliminated, the integral term will cease to grow. This will result in the proportional effect diminishing as the error decreases, but this is compensated for by the growing integral effect.

Term D is a best estimate of the future trend of the error, based on its current rate of change. It is sometimes called “anticipatory control”, as it is effectively seeking to reduce the effect of the error by exerting a control influence generated by the rate of error change. The more rapid the change, the greater the controlling or dampening effect.

The impact of each term is controlled by a respective non-negative coefficient. The velocity information (first time derivative) and the acceleration information (second time derivative), can be used to set the different coefficients in real time, e.g., based on a look-up table.

In general, a sequence of coordinates, first time derivatives and second time derivatives from a starting time instant can be represented by a matrix of state vectors T indexed by time t;

$$T ( t ) = [ \begin{matrix}{x}_{T} ( t ) \\ {v}_{T} ( t ) \\ {a}_{T} ( t )\end{matrix} ] ,$$

where x_{T}(t) denotes a coordinate vector, V_{T}(t) denotes velocity vector, and a_{T}(t) denotes acceleration vector as function of time t. The sequence may also comprise other quantities such as turn rate and so on. An error vector at time t can be defined as a difference between a predicted control state vector

$$P ( t ) = [ \begin{matrix}{x}_{P} ( t ) \\ {v}_{P} ( t ) \\ {a}_{P} ( t )\end{matrix} ]$$

at time t and the matrix T(t);

$$e ( t ) = [ \begin{matrix}{x}_{P} ( t ) \\ {v}_{P} ( t ) \\ {a}_{P} ( t )\end{matrix} ] - [ \begin{matrix}{x}_{T} ( t ) \\ {v}_{T} ( t ) \\ {a}_{T} ( t )\end{matrix} ] .$$

A prediction algorithm for predicting the state of the control input device can be based on minimizing, e.g., a squared error e(t)^{T}e(t) between the predicted coordinate values or entire state value and the actual coordinate or state corresponding to the prediction. Such prediction algorithms can be based on a plurality of known tracking filter methods, such as Kalman filters, extended Kalman filters, Wiener filters, and variants of a particle filter. Thus, the actuator control unit 520 can be configured to predict the coordinate value x(t) based on a Kalman filter algorithm or a sequential minimum mean-squared error, MMSE, algorithm.

A neural network can also be used to predict a current coordinate value x(T) based on a delayed coordinate value x(t−T) and a corresponding first time derivative. The actuator control unit 520 is optionally configured to predict the coordinate value x(t) based on a neural network trained on training data comprising a first and a second sequence of coordinate values where the second sequence of coordinate values is a delayed version of the first sequence, and where the delay corresponds to the time delay between a control device and the actuator control unit 520. The neural network can be arranged to accept only coordinate and time derivative data and to output predicted coordinates at one or more prediction time horizons. However, improved performance may be obtained if the neural network is configured to take more input data, such as current pose, current operating condition, and so on. The neural network can also be trained at least in part for a given operator, and thus be tailored to a particular operator or to a group of operators. Thus the construction machine can be tailored or customized by training it for a given operator or group of operators.

Many different types of neural networks can of course be used to generate the desired functionality; however, it has been found that a long short-term memory (LSTM) artificial recurrent neural network architecture often delivers very good results.

It is appreciated that the receiver 510 and the actuator control unit 520 may be implemented as physically separate units or at least partially comprised in the same circuit. Some or all of the functionality herein disclosed as performed in the actuator control unit may in fact be executed physically on a radio transceiver circuit which then comprises at least parts of the actuator control unit from a functional perspective. Also, the actuator control unit 520 may be implemented on a circuit which also performs some of the radio functions here discussed as performed by the receiver 510.

The same can be said for the processing unit 320 and the transmitter 330. Parts of the functionality discussed herein can be implemented physically in a radio transceiver device, which then comprises parts or all of the processing unit 320 functionality.

The same can also be said for the processing unit 610 and the transmitter 330 shown in FIG. 6. I.e., generally, the different functions discussed herein may be freely distributed over one or more circuits, such as a radio transceiver circuit and a processing unit.

FIG. 9A is a flow chart illustrating a method. There is illustrated a method performed in a control device 200, 300, 800 for controlling one or more actuators 110, 120, 130, 140 on a construction machine 100, the method comprises receiving S1a a manual control command from an operator for controlling the one or more actuators, and outputting S2a a coordinate s(t), x(t) indicative of the manual control command as function of time t, the method also comprises determining S3a a first time derivative v(t) of the coordinate x(t), and transmitting S4a a data signal 340 indicative of the coordinate x(t) and the first time derivative v(t) of the coordinate x(t) to an actuator control unit 520 of the construction machine 100, thereby enabling compensation for a time delay T between the control device and the construction machine by the actuator control unit 520.

FIG. 9B is a flow chart illustrating a method. There is illustrated a method performed in an actuator control unit 520 for controlling one or more actuators 110, 120, 130, 140 on a construction machine 100. The method comprises receiving S1b a data signal 340 indicative of a delayed manual control command input by an operator for controlling the one or more actuators 110, 120, 130, 140 and also indicative of a first time derivative v(t−T) of the delayed manual control command, the method also comprises predicting S2b a coordinate value x(t) indicative of a current manual control command input by the operator based on the data signal 340, and generating S3b a control command c(t) for controlling the one or more actuators 110, 120, 130, 140 based on the predicted coordinate value, thereby compensating for a time delay T between the control device and the actuator control unit 520.

FIG. 10 schematically illustrates, in terms of a number of functional units, the general components of a control unit 1000. This control unit can be used to implement, e.g., parts of the control device 200, 300, 600 800 or the actuator control unit 520. Processing circuitry 1010 is provided using any combination of one or more of a suitable central processing unit CPU, multiprocessor, microcontroller, digital signal processor DSP, etc., capable of executing software instructions stored in a computer program product, e.g. in the form of a storage medium 1030. The processing circuitry 1010 may further be provided as at least one application specific integrated circuit ASIC, or field programmable gate array FPGA.

Particularly, the processing circuitry 1010 is configured to cause the device 1000 to perform a set of operations, or steps, such as the methods discussed in connection to FIG. 6 and the discussions above. For example, the storage medium 1030 may store the set of operations, and the processing circuitry 1010 may be configured to retrieve the set of operations from the storage medium 1030 to cause the device to perform the set of operations. The set of operations may be provided as a set of executable instructions. Thus, the processing circuitry 1010 is thereby arranged to execute methods as herein disclosed.

The storage medium 1030 may also comprise persistent storage, which, for example, can be any single one or combination of magnetic memory, optical memory, solid state memory or even remotely mounted memory.

The device 130, 420 may further comprise an interface 1020 for communications with at least one external device. As such the interface 1020 may comprise one or more transmitters and receivers, comprising analogue and digital components and a suitable number of ports for wireline or wireless communication.

The processing circuitry 1010 controls the general operation of the control unit 130, 420, e.g., by sending data and control signals to the interface 1020 and the storage medium 1030, by receiving data and reports from the interface 1020, and by retrieving data and instructions from the storage medium 1030.

FIG. 11 illustrates a computer readable medium 1110 carrying a computer program comprising program code means 1120 for performing the methods illustrated in FIG. 9, when said program product is run on a computer. The computer readable medium and the code means may together form a computer program product 1100.

1. A control device for controlling one or more actuators on a construction machine,
the control device comprising a control input arrangement configured to receive a manual control command from an operator for controlling the one or more actuators, and to output a coordinate indicative of the manual control command as function of time,
the control device further comprising a processing unit arranged to determine a first time derivative of the coordinate, and
a transmitter arranged to transmit a data signal indicative of the coordinate and the first time derivative of the coordinate to an actuator control unit of the construction machine, thereby enabling compensation for a time delay between the control device and the construction machine by the actuator control unit,
wherein the time delay to be compensated for is based on a pre-determined calibration setting.

2. The control device according to claim 1, wherein the processing unit is arranged to determine a second time derivative of the coordinate, and wherein the transmitter is arranged to also transmit a data signal indicative of the second time derivative of the coordinate to the actuator control unit.

3. The control device according to claim 1, wherein the transmitter is arranged to transmit data to the actuator control unit at a transmission rate, wherein the control device is arranged to sample the coordinate at a rate exceeding the transmission rate, and to determine the first and/or the second time derivative based on a time difference of sampled coordinate values.

4. The control device according to claim 1, wherein the control input arrangement comprises any of: one or more joysticks, one or more touch screens, one or more gesture control input gloves, and one or more haptic control input gloves.

5. The control device-according to claim 1, wherein the control device is a remote control device for controlling the construction machine over a wireless link, and wherein the transmitter is a radio frequency transmitter arranged to transmit a wireless signal to an actuator control unit on the construction machine.

6. The control device according to claim 1, wherein the control device is an in-cabin or an on-machine control device for controlling the construction machine over a wired communication interface, and wherein the transmitter is arranged to transmit a data signal to the actuator control unit of the construction machine over the wired communication interface.

7. The control device according to claim 1, wherein the control device is arranged to obtain a finite length sequence of coordinates as function of time, and also a pre-determined set of motion models indicating respective motion patterns of the control input arrangement, wherein the processing unit is arranged to select a motion model out of the set of motion models which matches the sequence of coordinates based on a pre-determined matching criterion, and wherein the transmitter is arranged to transmit data indicating the selected motion model to the actuator control unit.

8. A control device for controlling one or more actuators on a construction machine,
the control device comprising a control input arrangement configured to receive a manual control command from an operator for controlling the one or more actuators and to output a coordinate indicative of the control command as function of time,
a processing unit arranged to determine a first time derivative of the coordinate, and to predict a future coordinate value indicating a future manual control command based on the coordinate and on the first time derivative, and
a transmitter arranged to transmit a data signal indicative of the future coordinate value to the construction machine, thereby compensating for a time delay between the control device and the construction machine,
wherein the time delay to be compensated for is based on a pre-determined calibration setting.

9. An actuator control unit for controlling one or more actuators on a construction machine,
wherein the actuator control unit is arranged to receive a data signal comprising a delayed manual control command input by an operator for controlling the one or more actuators and also comprising a first time derivative of the delayed manual control command,
wherein the actuator control unit is configured to predict a coordinate value indicative of a current manual control command input by the operator based on the data signal comprising the delayed manual control command and the first time derivative, and
wherein the actuator control unit is configured to generate a control command for controlling the one or more actuators based on the predicted coordinate value, thereby compensating for a time delay between the control device and the actuator control unit,
wherein the time delay to be compensated for is based on a pre-determined calibration setting.

10. The actuator control unit according to claim 9,
wherein the control unit is further arranged to receive a data signal comprising a second time derivative of the delayed manual control command, and wherein the actuator control unit is configured to predict the coordinate value indicative of the current manual control command input by the operator based also on the second time derivative of the delayed manual control command.

11. The actuator control unit according to claim 9, arranged to determine a prediction error by comparing the predicted coordinate value to a corresponding future coordinate value, and to adjust the delay value to be compensated for by the predicted coordinate value based on a magnitude of the prediction error, such that a small error results in a longer delay value to be compensated for compared to a larger error.

12. The actuator control unit according to claim 9, wherein the actuator control unit is configured to predict the coordinate value indicative of a current control command by the operator in dependence of the control command, wherein the actuator control unit is configured to associate a delay to be compensated for by the predicted coordinate value in dependence of the control command.

13. The actuator control unit according claim 9, wherein the actuator control unit is configured to predict the coordinate value based on a PID regulator algorithm, or wherein the actuator control unit is configured to predict the coordinate value based on a Kalman filter algorithm or a sequential minimum mean-squared error, MMSE, algorithm.

14. (canceled)

15. The actuator control unit according to claim 9, wherein the actuator control unit is configured to predict the coordinate value based on a neural network trained on training data comprising a first and a second sequence of coordinate values wherein the second sequence of coordinate values is a delayed version of the first sequence, and wherein the delay corresponds to the time delay between a control device and the actuator control unit.

16. The actuator control unit according to claim 15, wherein the neural network is configured to be trained for a given operator or group of operators, or wherein the neural network comprises a long short-term memory, LSTM, artificial recurrent neural network architecture.

17. (canceled)

18. The actuator control unit according to claim 9, wherein the actuator control unit is arranged to receive a data signal comprising a sequence of control command coordinates associated with a coordinate update rate, wherein the actuator control unit is configured to predict the coordinate value at a rate above the coordinate update rate, and/or to generate the control command for controlling the one or more actuators at a control update rate above the coordinate update rate.

19. The actuator control unit according to claim 9, arranged to obtain a finite length sequence of coordinates as function of time, and also a pre-determined set of motion models indicating respective motion patterns of the control input arrangement, wherein the actuator control unit is arranged to select a motion model out of the set of motion models which matches the sequence of coordinates based on a pre-determined matching criterion, and to predict the coordinate value indicative of the current manual control command based on the selected motion model.

20. (canceled)

21. An actuator control unit or controlling one or more actuators on a construction machine,
wherein the actuator control unit is arranged to receive a sequence of coordinates indicative of a delayed manual control command input sequence by an operator for controlling the one or more actuators,
wherein the actuator control unit is configured to predict a coordinate value indicative of a current manual control command input by the operator based on an extrapolated value of the received sequence of coordinates, and
wherein the actuator control unit is configured to generate a control command for controlling the one or more actuators based on the predicted coordinate value, thereby compensating for a time delay between the control device and the actuator control unit,
wherein the time delay to be compensated for is based on a pre-determined calibration setting.

22. The actuator control unit according to claim 21, wherein the actuator control unit is configured to predict the coordinate value based on a Kalman filter algorithm or a sequential minimum mean-squared error, MMSE, algorithm.

23. The actuator control unit according to claim 21, wherein the actuator control unit is configured to predict the coordinate value based on a neural network trained on training data comprising a first and a second sequence of coordinate values where the second sequence of coordinate values is a delayed version of the first sequence, and where the delay corresponds to the time delay between a control device and the actuator control unit.

24. The actuator control unit according to claim 23, wherein the neural network is configured to be trained for a given operator or group of operators, or wherein the neural network comprises a long short-term memory, LSTM, artificial recurrent neural network architecture.

25. (canceled)

26. The actuator control unit according to claim 21, wherein the actuator control unit is configured to determine a first time derivative and/or a second time derivative associated with a manual control command input by the operator based on the received sequence of coordinates.
